(19) United States
(12) Patent Application Publication
(10) Pub. No.: US 2013/0258142 A1
(43) Pub. Date: Oct. 3, 2013

(54) METHODS AND SYSTEMS FOR REDUCING NOISE IN BIOMETRIC DATA ACQUISITION

(71) Applicant: Validity Sensors, Inc., San Jose, CA (US)

(72) Inventor: Anthony P. RUSSO, New York, NY (US)

(21) Appl. No.: 13/851,771

(22) Filed: Mar. 27, 2013

Related U.S. Application Data
(60) Provisional application No. 61/616,319, filed on Mar. 27, 2012.

(51) Int. Cl. H04N 5/217

(52) U.S. Cl. CPC H04N 5/217
USPC 348/241

(57) ABSTRACT

A system and method for reducing noise in biometric sensor image data may comprise: capturing a first frame of biometric image data and a second frame of biometric image data; selecting one of the first frame and the second frame as a reference frame; filtering one of the reference frame and the other frame of the first frame and the second frame, with the other frame or the reference frame, and culling one of the other frame and the reference frame and selecting the un-culled one of the other frame and the reference frame as a new reference frame; and repeating the capturing, filtering and culling one of a new first frame and a new reference frame and selecting the un-culled one of the new first frame and the new reference frame as a further new reference frame.

### RELATED CASES

The present Application relies for priority on U.S. Provisional Patent Application No. 61/616,319, entitled METHODS AND SYSTEMS FOR REDUCING NOISE IN BIOMETRIC DATA ACQUISITION, filed on Mar. 27, 2012, the disclosure of which is incorporated herein by reference for all purposes, as if the specification, claims and drawing of which were physically reproduced in the present application.

### BACKGROUND OF THE INVENTION

Personal verification systems utilize a variety of systems and methods to protect information and property and to authenticate authorized users. Some protection systems rely on information acquired by biometric sensors relating to the biometric features of a user's body. The use of biometric information for authentication is advantageous, because each biometric feature is unique to the user. Any biometric feature can be used, including facial features, a retinal image, palm print, fingerprint, or signature. Where the biometric feature is a fingerprint, the biometric sensor obtains information representative of the user's fingerprint.

A disadvantage of biometric sensors is background noise. Background noise caused, for example, by non-uniformity among the transistors of a sensor or environmental conditions, such as dirt, interferes with the signal produced by the sensor, making it difficult to produce a clear image or representation of the biometric feature. Background noise can be problematic for capacitive sensors as well as for sensors which detect speech. For example, for a capacitive sensor that images fingerprints, the background noise generated by the sensor makes it difficult to accurately image very dry fingers. A dry finger placed on the sensor produces a weak signal that can be obscured by the background noise of the sensor. As a result, it may be difficult to determine the unique minutiae from the resulting image or representation of the fingerprint, thereby hampering either enrollment and later the the identification or authentication process.

Another problem with biometric sensors, particularly ones in which the user places a body part directly on the sensor, is the remnant of a latent print. For example, natural oil from the user's hand can leave a residue of a fingerprint or palm print on the sensor. Under the right conditions, the sensor can be made to read the latent print as if there was an actual finger on the device, and the user could obtain unauthorized access to the protected system.

U.S. Pat. No. 6,535,622 B1 issued Mar. 18, 2003, to Russo et al., for Method for Imaging Fingerprints and Concealing Latent Fingerprints,” describes a method of operating a personal verification system that includes acquiring with a sensor a first image of a first biometric feature, removing background noise associated with the sensor from the image, and storing at least a portion of the first image. U.S. Pat. No. 6,330,345 B1 issued Dec. 11, 2001, to Russo et al., for “Automatic Adjustment Processing for Sensors Devices,” describes a system and method for automatically determining a set of default settings (with respect to a blank image) so that a uniform and high contrast image results when, for example, a finger is present on a sensor device.

There is a need, therefore, for a methods and systems for reducing noise in biometric data acquisition systems and methods.

### SUMMARY OF THE INVENTION

A system and method for reducing noise in biometric sensor image data produced by a biometric image sensor is disclosed, which may comprise: capturing with the biometric image sensor a first frame of biometric image data; capturing with the biometric image sensor a second frame of biometric image data; selecting one of the first frame and the second frame as a reference frame; filtering one of the reference frame and the other frame of the first frame and the second frame, respectively, with the other frame or the reference frame, and culling one of the other frame and the reference frame and selecting the un-culled one of the other frame and the reference frame as a new reference frame; capturing with the biometric image sensor a new first frame; filtering one of the new reference frame and the new first frame, respectively, with the other of the new first frame or the new reference frame, and culling one of the new first frame and the new reference frame and selecting the un-culled one of the new first frame and the new reference frame as a further new reference frame. The system and method may further comprise the first frame and the second frame each comprising, respectively, at least a portion of a respective first linear array sensor scan and a respective second linear array sensor scan or the first frame and the second frame each comprising, respectively, at least a portion of a respective first two-dimensional array sensor scan and a respective second two-dimensional array sensor scan.

The system and method may further comprise the culling one of the other frame and the reference frame and selecting the un-culled one of the other frame and the reference frame as a new reference frame comprising averaging the one of the at least a portion of a respective first linear array sensor scan and the at least a portion of the respective second linear array sensor scan. The system and method may further comprise selecting the un-culled one of the other linear array sensor scan and the reference linear array sensor scan comprises averaging the other linear array sensor scan and the reference linear array sensor scan; and selecting the un-culled one of the new first linear array sensor scan and the new reference linear array sensor scan as a further new reference linear array sensor scan comprises averaging the new first linear array sensor scan and the further reference linear array sensor scan.

The culling one of the other frame and the reference frame and selecting the un-culled one of the other frame and the reference frame as a new reference frame may comprise averaging the one of the at least a portion of a respective two-dimensional first array sensor scan and the at least a portion of the respective second two-dimensional array sensor scan. Selecting the un-culled one of the other two-dimensional sensor scan and the reference two-dimensional array sensor scan may comprise averaging the other two-dimensional array sensor scan and the reference two-dimensional array sensor scan; and selecting the un-culled one of the new first two-dimensional array sensor scan and the new reference two-dimensional array sensor scan as a further new reference two-dimensional array sensor scan may comprise averaging the new first two-dimensional array sensor scan and the further reference two-dimensional array sensor scan.

The system and method may further comprise determining whether at least a portion of an image of a finger is present in the respective first linear array sensor scan and the respective second linear array sensor scan or determining whether at least a portion of an image of a finger is present in the respective first two-dimensional array sensor scan and the respective second two-dimensional array sensor scan.

Also disclosed is a machine readable medium storing software instructions which, when executed by a computing device, causes the computing device to perform a method, the method may comprise: capturing with the biometric image sensor a first frame of biometric image data; capturing with the biometric image sensor a second frame of biometric image data; selecting one of the first frame and the second frame as a reference frame; filtering one of the reference frame and the other frame of the first frame and the second frame, respectively, with the other frame or the reference frame, and culling one of the other frame and the reference frame and selecting the un-culled one of the other frame and the reference frame as a new reference frame; capturing with the biometric image sensor a new first frame; filtering one of the new reference frame and the new first frame, respectively, with the other of the new first frame or the new reference frame, and culling one of the new first frame and the new reference frame and selecting the un-culled one of the new first frame and the new reference frame as a further new reference frame.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

Additional references of interest include, for example, U.S. Pat. No. 7,099,496 issued Aug. 29, 2006, to Benkley, for “Swiped Aperture Capacitive Fingerprint Sensing Systems and Methods; ” U.S. Pat. No. 7,463,756 issued Dec. 9, 2008, to Benkley for “Finger Position Sensing Methods and Apparatus; ” U.S. Pat. No. 7,751,601 issued Jul. 6, 2010, to Benkley for “Finger Sensing Assemblies and Methods of Making; ” U.S. Pat. No. 7,460,697 issued Dec. 2, 2008 to Erhart for “Electronic Fingerprint Sensor with Differential Noise Cancellation; ” U.S. Pat. No. 7,953,258 issued May 31, 2011, to Dean et al. for “Fingerprint Sensing Circuit Having Programmable Sensing Patterns; ” and U.S. Pat. No. 6,941,001 issued Sep. 6, 2005, to Bolle for Combined Fingerprint Acquisition and Control Device.”

### DETAILED DESCRIPTION OF THE INVENTION

The systems and methods provided collect biometric data from a biometric sensor, such as a fingerprint sensor, in a way that can reduce noise inherent in the samples, e.g., using some form of filtering, such as, an averaging or other digital filtering method. For implementations with respect to one-dimensional (1D) sensors, culled lines may be used to reduce noise by, e.g., averaging the culled lines together and/or by replacing a reference line with the averaged line. The act of averaging reduces the noise present in the averaged line. As will be appreciated by those skilled in the art, other techniques of combining past culled lines together to reduce the noise are also possible without departing from the scope of the disclosure. Other techniques can include, for example, median filtering.

A two-dimensional (2D) sensor is also configurable such that the 2D sensor captures a biometric sample “frame” (a 2D image) rapidly [e.g., multiple times per second or at whatever rate (e.g., #/time) is desirable under the implementation]. If the finger is not moving during this time, the images in each frame will be highly redundant. For a 2D sensor, culling (and, for example, averaging to reduce noise) could still operate line-by-line as it does in the 1D implementation (“1D frame”), though covering a 2D area rather than a 1D linear array scanned line.

In at least some configurations, a complete, or substantially complete, 2D biometric image (“frame”) can be gathered prior to culling. Culling can be achieved by using multiple rows and columns, or subsets thereof. Additionally standard measures of image similarity (e.g., correlation, pixel differences, histogram differences, etc.) can be used to determine if one frame is similar enough to the next frame such that one of the frames should be culled. If it is deemed similar enough to a reference frame, the reference frame may be updated by averaging (or, e.g., median filtering, etc.) with the new culled frame to obtain a less noisy image. Additionally, the entire image could be combined with the reference or, in an alternative, only a subset of the image pixels could be combined.

As will be appreciated by those skilled in the art, 2D culling, as an example, implemented in hardware, can be used to reduce the bandwidth used during data acquisition because only non-redundant frames, or subsets thereof, need to be sent to a host or other computing device for further processing and analysis.

In still another aspect of the disclosure, a 2D sensor can be configured to capture a biometric sample frame (e.g., a 2-dimensional image) rapidly (e.g., multiple times per second or at other rates, as desired). The rate at which it captures a single frame is likened to a camera's shutter speed. A fast speed can be used to ensure there is no blurring due to finger movement during frame capture. The fast shutter speed can also be used to allow for a high frame rate, e.g., impacting how many complete 2D frames/images can be sent to a host per second. A high frame rate can be used to reduce a sensor response time experienced or perceived by the user. However, a disadvantage is that faster frame capture can result in a lot of data being sent over a bus with limited bandwidth, and it can be a burden for the host to process so many frames at a high rate of transmission. A hardware culling operation can be used to reduce the rate of frames sent if they are redundant.

However, when a finger first comes into contact with a sensor, or the finger is moving for some other reason, culling will not apply and a lot of frames may be sent to the host. In this case it can be necessary for the host to efficiently determine which, if any, frame or frames to process further (e.g. for enrollment or matching purposes, or for user feedback, and the like). This embodiment describes mechanisms for efficiently performing this frame selection process.

An aspect of the disclosure is directed to determining when an image is ready for enrollment, matching or user quality feedback. It will be appreciated that different criteria may be applied for enrollment versus verification versus feedback. To accomplish this, the system and methods must take into account multiple factors. A first factor may be whether a finger is present in the image or not, and to what extent the finger is present (e.g. partial touching, full sensor coverage, etc.). This may be important because if a finger is not present, then the system and methods may decide to wait longer for a finger to arrive (e.g., be applied to the sensor), or prompt the user to place his/her finger on the device.

If a finger is present, a next factor may be whether that finger has settled to the point where it has stopped moving, or, if it continues to move, whether future frames are likely to contain additional finger data or not.

As will be appreciated by those skilled in the art, multiple metrics can be used to estimate these factors. For example, to determine how much of a finger is present, a histogram of gray scale pixel values can be computed and compared to a known baseline or threshold. If enough darker pixels, which correspond to a signal such as a fingerprint ridge, are present, or there is enough increased variance in the image, a determination can be made that a finger present and the nature, extent and quality of the presence of the finger.

To determine whether a finger has settled and stopped moving, a measurement of an image standard may be applied to determine similarity (e.g. pixel gray level value differences, histogram differences, etc.) to determine if one frame is similar enough to the previous one. This process is similar, and can even be redundant to, the process of image culling, so if that is performed in hardware then in some cases it may be sufficient simply to know when culling is occurring (i.e. exactly when and how many frames were culled). This can be achieved through adding header information to each image frame sent by the sensor.

If there is slight finger movement, however, the above techniques for determining whether a finger has settled may fail. Therefore, it may be necessary to try and detect the motion to tell the difference between a moving finger that is in good contact with the sensor versus a non-moving finger that has yet to settle fully on he device. Cross-correlation can be used for this purpose, but it is important to apply it efficiently. It can take too much computing time to fully correlate an entire frame to another. Therefore, it may be desirable to be more efficient. Small areas may be correlatable to estimate motion in two dimensions. Such small areas may be square, rectangular or any other shape that is conducive for the desired form factor. Small areas can be, for example, a 1×1, 2×2, 3×3, 4×4, 5×5, 6×6, 8×8, 9×9, or 10×10 square regions, or the like, e.g., circles or approximations thereof, polygons or approximations thereof, etc. One or more such regions can be placed strategically around the sensing area, of like or different shape, e.g., to improve coverage. The regions may also be rectangular (e.g., 1×2, 1×3, 1×4, 2×3, 2×4, etc.), linear or any other suitable geometric shape. The number of points used in the correlation calculation can be selected such that the frame rate can be maintained and the use of host computing resources to is minimized. Where, for example, the available host computing resource is not an issue, other sizes, shapes, an/or the number of points used can be altered.

The frame selection algorithm therefore has various metrics to use to determine at any given time what is happening: finger on, finger off, finger partially on and settled, finger partially on and not settled, finger fully on but moving, finger fully on and settled. Depending on what is happening and what biometric processing mode the system is in (enrollment versus verification), one may then apply logic to determine whether to discard or keep a frame for further processing. Typically, a frame is selected for enrollment when it is fully settled and covers an adequate area of the sensor. Similarly, a frame may be selected for verification when it is fully settled or slightly before for faster system response times, without the requirement that it cover much of the sensing area. In the cases when a frame cannot be chosen for enrollment or verification within a preselected time period, the user may be prompted with feedback on image quality. This can also be the case if one or more frames are chosen for verification but none of them are able to be matched, and image quality issues such as partial sensor coverage are detected by the system. Frames that are not selected can be discarded and need not go through further processing unless there are other reasons to do so.

For a 2D sensor array embodiment it may be possible, e.g., to filter, e.g., to average 2D images together even if the finger has moved on the sensor, as long as the motion is calculated, e.g., through correlation. Such may include, by way of example, a 2D version of how one can do correlation navigation, as is discussed in more detail, e.g., in U.S. patent application Ser. No. 13/014,507, filed on Jan. 26, 2011, entitled USER INPUT UTILIZING DUAL LINE SCANNER APPARATUS AND METHODS, Publ. No. US 2012-0198166 A1, published on Mar. 18, 2011. If the delta X and delta Y for one image frame to the next can be determined, e.g. by such image pixel array correlation, it is possible to average the two images together. However, one must also look for overall similarity between the two images, after the X and Y shifts are taken into account, e.g., in order to make sure there is not any significant new or changed information present in one frame but not the other. For example, consider the case where a finger is slowly placed on the 2D sensor at time T=0 so that only the middle portion of the finger contacts the sensor. At time T=1 it is then pushed down harder, so that more of the areas surrounding the middle of the finger contacts the sensor. In this case, if one were to correlate a small block of image data in Frame 0 to Frame 1, a high correlation would likely be found, indicating that the finger had not moved (both images could, e.g., contain the middle part of the finger, and the finger is indicated, for this example anyway, to be stationary). However, areas of the full Image 0 could be empty, whereas those same areas in Image frame 1 could then contain fingerprint ridge/valley information. In such a case averaging ought not to be used, as this could water down those new areas.

It will be understood by those skilled in the art that the disclosed subject matter provides a biometric authentication system wherein a biometric image sensor can be incorporated into a user authentication apparatus providing user authentication, e.g., for controlling access to one of an electronic user device or an electronically provided service. The electronic user device may comprise at least one of a portable phone and a computing device. The electronically provided service may comprise at least one of providing access to a web site or to an email account. The biometric image sensor may be incorporated into a user authentication apparatus providing user authentication for controlling an online transaction. The user authentication apparatus may be a replacement of at least one of a user password or personal identification number. The user authentication apparatus may be incorporated into an apparatus providing user authentication for controlling access to a physical location, or providing user authentication demonstrating the user was present at a certain place at a certain time. The user authentication apparatus may be incorporated into an apparatus providing at least one of a finger motion user input or navigation input to a computing device. The user authentication apparatus may be incorporated into an apparatus providing authentication of the user to a user device and the performance by the user device of at least one other task, e.g., specific to a particular finger of the user. The user authentication apparatus may be incorporated into an apparatus providing user authentication for purposes of making an on-line transaction non-repudiatable.

It will also be understood that a system and method for reducing noise in biometric sensor image data produced by a biometric image sensor is disclosed, which may comprise: capturing with the biometric image sensor a first frame of biometric image data; capturing with the biometric image sensor a second frame of biometric image data; selecting one of the first frame and the second frame as a reference frame; filtering one of the reference frame and the other frame of the first frame and the second frame, respectively, with the other frame or the reference frame, and culling one of the other frame and the reference frame and selecting the un-culled one of the other frame and the reference frame as a new reference frame; capturing with the biometric image sensor a new first frame; filtering one of the new reference frame and the new first frame, respectively, with the other of the new first frame or the new reference frame, and culling one of the new first frame and the new reference frame and selecting the un-culled one of the new first frame and the new reference frame as a further new reference frame. The system and method may further comprise the first frame and the second frame each comprising, respectively, at least a portion of a respective first linear array sensor scan and a respective second linear array sensor scan or the first frame and the second frame each comprising, respectively, at least a portion of a respective first two-dimensional array sensor scan and a respective second two-dimensional array sensor scan.

The system and method may further comprise the culling one of the other frame and the reference frame and selecting the un-culled one of the other frame and the reference frame as a new reference frame comprising averaging the one of the at least a portion of a respective first linear array sensor scan and the at least a portion of the respective second linear array sensor scan. The system and method may further comprise selecting the un-culled one of the other linear array sensor scan and the reference linear array sensor scan comprises averaging the other linear array sensor scan and the reference linear array sensor scan; and selecting the un-culled one of the new first linear array sensor scan and the new reference linear array sensor scan as a further new reference linear array sensor scan comprises averaging the new first linear array sensor scan and the further reference linear array sensor scan.

The culling one of the other frame and the reference frame and selecting the un-culled one of the other frame and the reference frame as a new reference frame may comprise averaging the one of the at least a portion of a respective two-dimensional first array sensor scan and the at least a portion of the respective second two-dimensional array sensor scan. Selecting the un-culled one of the other two-dimensional sensor scan and the reference two-dimensional array sensor scan may comprise averaging the other two-dimensional array sensor scan and the reference two-dimensional array sensor scan; and selecting the un-culled one of the new first two-dimensional array sensor scan and the new reference two-dimensional array sensor scan as a further new reference two-dimensional array sensor scan may comprise averaging the new first two-dimensional array sensor scan and the further reference two-dimensional array sensor scan.

The system and method may further comprise determining whether at least a portion of an image of a finger is present in the respective first linear array sensor scan and the respective second linear array sensor scan or determining whether at least a portion of an image of a finger is present in the respective first two-dimensional array sensor scan and the respective second two-dimensional array sensor scan.

Also disclosed is a machine readable medium storing software instructions which, when executed by a computing device, causes the computing device to perform a method, the method may comprise: capturing with the biometric image sensor a first frame of biometric image data; capturing with the biometric image sensor a second frame of biometric image data; selecting one of the first frame and the second frame as a reference frame; filtering one of the reference frame and the other frame of the first frame and the second frame, respectively, with the other frame or the reference frame, and culling one of the other frame and the reference frame and selecting the un-culled one of the other frame and the reference frame as a new reference frame; capturing with the biometric image sensor a new first frame; filtering one of the new reference frame and the new first frame, respectively, with the other of the new first frame or the new reference frame, and culling one of the new first frame and the new reference frame and selecting the un-culled one of the new first frame and the new reference frame as a further new reference frame.

The following is a disclosure by way of example of a computing device which may be used with the presently disclosed subject matter. The description of the various components of a computing device is not intended to represent any particular architecture or manner of interconnecting the components. Other systems that have fewer or more components may also be used with the disclosed subject matter. A communication device may constitute a form of a computing device and may at least emulate a computing device. The computing device may include an inter-connect (e.g., bus and system core logic), which can interconnect such components of a computing device to a data processing device, such as a processor(s) or microprocessor(s), or other form of partly or completely programmable or pre-programmed device, e.g., hard wired and/or application specific integrated circuit (“ASIC”) customized logic circuitry, such as a controller or microcontroller, a digital signal processor, or any other form of device that can fetch instructions, operate on pre-loaded/pre-programmed instructions, and/or follow instructions found in hard-wired or customized circuitry, to carry out logic operations that, together, perform steps of and whole processes and functionalities as described in the present disclosure.

In this description, various functions, functionalities and/or operations may be described as being performed by or caused by software program code to simplify description. However, those skilled in the art will recognize what is meant by such expressions is that the functions resulting from execution of the program code/instructions are performed by a computing device as described above, e.g., including a processor, such as a microprocessor, microcontroller, logic circuit or the like. Alternatively, or in combination, the functions and operations can be implemented using special purpose circuitry, with or without software instructions, such as using Application-Specific Integrated Circuit (ASIC) or Field-Programmable Gate Array (FPGA), which may be programmable, partly programmable or hard wired. The application specific integrated circuit (“ASIC”) logic may be such as gate arrays or standard cells, or the like, implementing customized logic by metalization(s) interconnects of the base gate array ASIC architecture or selecting and providing metalization(s) interconnects between standard cell functional blocks included in a manufacturers library of functional blocks, etc. Embodiments can thus be implemented using hardwired circuitry without program software code/instructions, or in combination with circuitry using programmed software code/instructions.

Thus, the techniques are limited neither to any specific combination of hardware circuitry and software, nor to any particular tangible source for the instructions executed by the data processor(s) within the computing device. While some embodiments can be implemented in fully functioning computers and computer systems, various embodiments are capable of being distributed as a computing device including, e.g., a variety of forms and capable of being applied regardless of the particular type of machine or tangible computer-readable media used to actually effect the performance of the functions and operations and/or the distribution of the performance of the functions, functionalities and/or operations.

The interconnect may connect the data processing device to define logic circuitry including memory. The interconnect may be internal to the data processing device, such as coupling a microprocessor to on-board cache memory, or external (to the microprocessor) memory such as main memory, or a disk drive, or external to the computing device, such as a remote memory, a disc farm or other mass storage device(s), etc. Commercially available microprocessors, one or more of which could be a computing device or part of a computing device, include a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc, or a 68xxx series microprocessor from Motorola Corporation as examples.

The inter-connect in addition to interconnecting such as microprocessor(s) and memory may also interconnect such elements to a display controller and display device, and/or to other peripheral devices such as input/output (I/O) devices, e.g., through an input/output controller(s). Typical I/O devices can include a mouse, a keyboard(s), a modem(s), a network interface(s), printers, scanners, video cameras and other devices which are well known in the art. The inter-connect may include one or more buses connected to one another through various bridges, controllers and/or adapters. In one embodiment the I/O controller may include a USB (Universal Serial Bus) adapter for controlling USB peripherals, and/or an IEEE-1394 bus adapter for controlling IEEE-1394 peripherals.

The memory may include any tangible computer-readable media, which may include but are not limited to recordable and non-recordable type media such as volatile and non-volatile memory devices, such as volatile RAM (Random Access Memory), typically implemented as dynamic RAM (DRAM) which requires power continually in order to refresh or maintain the data in the memory, and non-volatile ROM (Read Only Memory), and other types of non-volatile memory, such as a hard drive, flash memory, detachable memory stick, etc. Non-volatile memory typically may include a magnetic hard drive, a magnetic optical drive, or an optical drive (e.g., a DVD RAM, a CD ROM, a DVD or a CD), or other type of memory system which maintains data even after power is removed from the system.

A server could be made up of one or more computing devices. Servers can be utilized, e.g., in a network to host a network database, compute necessary variables and information from information in the database(s), store and recover information from the database(s), track information and variables, provide interfaces for uploading and downloading information and variables, and/or sort or otherwise manipulate information and data from the database(s). In one embodiment a server can be used in conjunction with other computing devices positioned locally or remotely to perform certain calculations and other functions as may be mentioned in the present application.

At least some aspects of the disclosed subject matter can be embodied, at least in part, utilizing programmed software code/instructions. That is, the functions, functionalities and/or operations techniques may be carried out in a computing device or other data processing system in response to its processor, such as a microprocessor, executing sequences of instructions contained in a memory, such as ROM, volatile RAM, non-volatile memory, cache or a remote storage device. In general, the routines executed to implement the embodiments of the disclosed subject matter may be implemented as part of an operating system or a specific application, component, program, object, module or sequence of instructions usually referred to as “computer programs,” or “software.” The computer programs typically comprise instructions stored at various times in various tangible memory and storage devices in a computing device, such as in cache memory, main memory, internal or external disk drives, and other remote storage devices, such as a disc farm, and when read and executed by a processor(s) in the computing device, cause the computing device to perform a method(s), e.g., process and operation steps to execute an element(s) as part of some aspect(s) of the method(s) of the disclosed subject matter.

A tangible machine readable medium can be used to store software and data that, when executed by a computing device, causes the computing device to perform a method(s) as may be recited in one or more accompanying claims defining the disclosed subject matter. The tangible machine readable medium may include storage of the executable software program code/instructions and data in various tangible locations, including for example ROM, volatile RAM, non-volatile memory and/or cache. Portions of this program software code/instructions and/or data may be stored in any one of these storage devices. Further, the program software code/instructions can be obtained from remote storage, including, e.g., through centralized servers or peer to peer networks and the like. Different portions of the software program code/instructions and data can be obtained at different times and in different communication sessions or in a same communication session.

The software program code/instructions and data can be obtained in their entirety prior to the execution of a respective software application by the computing device. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a single machine readable medium in entirety at any particular instant of time.

In general, a tangible machine readable medium includes any tangible mechanism that provides (i.e., stores) information in a form accessible by a machine (i.e., a computing device), which may be included, e.g., in a communication device, a network device, a personal digital assistant, a mobile communication device, whether or not able to download and run applications from the communication network, such as the Internet, e.g., an I-phone, Blackberry, Droid or the like, a manufacturing tool, or any other device including a computing device, comprising one or more data processors, etc.

In one embodiment, a user terminal can be a computing device, such as in the form of or included within a PDA, a cellular phone, a notebook computer, a personal desktop computer, etc. Alternatively, the traditional communication client(s) may be used in some embodiments of the disclosed subject matter.

While some embodiments of the disclosed subject matter have been described in the context of fully functioning computing devices and computing systems, those skilled in the art will appreciate that various embodiments of the disclosed subject matter are capable of being distributed, e.g., as a program product in a variety of forms and are capable of being applied regardless of the particular type of computing device machine or computer-readable media used to actually effect the distribution.

The disclosed subject matter may be described with reference to block diagrams and operational illustrations of methods and devices to provide a system and methods according to the disclosed subject matter. It will be understood that each block of a block diagram or other operational illustration (herein collectively, “block diagram”), and combination of blocks in a block diagram, can be implemented by means of analog or digital hardware and computer program instructions. These computing device software program code/instructions can be provided to the computing device such that the instructions, when executed by the computing device, e.g., on a processor within the computing device or other data processing apparatus, the program software code/instructions cause the computing device to perform functions, functionalities and operations of a method(s) according to the disclosed subject matter, as recited in the accompanying claims, with such functions, functionalities and operations specified in the block diagram.

It will be understood that in some possible alternate implementations, the function, functionalities and operations noted in the blocks of a block diagram may occur out of the order noted in the block diagram. For example, the function noted in two blocks shown in succession can in fact be executed substantially concurrently or the functions noted in blocks can sometimes be executed in the reverse order, depending upon the function, functionalities and operations involved. Therefore, the embodiments of methods presented and described as a flowchart(s) in the form of a block diagram in the present application are provided by way of example in order to provide a more complete understanding of the disclosed subject matter. The disclosed flow and concomitantly the method(s) performed as recited in the accompanying claims are not limited to the functions, functionalities and operations illustrated in the block diagram and/or logical flow presented herein. Alternative embodiments are contemplated in which the order of the various functions, functionalities and operations may be altered and in which sub-operations described as being part of a larger operation may be performed independently or performed differently than illustrated or not performed at all.

Although some of the drawings may illustrate a number of operations in a particular order, functions, functionalities and/or operations which are not now known to be order dependent, or become understood to not be order dependent, may be reordered and other operations may be combined or broken out. While some reordering or other groupings may have been specifically mentioned in the present application, others will be or may become apparent to those of ordinary skill in the art and so the disclosed subject matter does not present an exhaustive list of alternatives. It should also be recognized that the aspects of the disclosed subject matter may be implemented in parallel or seriatim in hardware, firmware, software or any combination(s) thereof co-located or remotely located, at least in part, from each other, e.g., in arrays or networks of computing devices, over interconnected networks, including the Internet, and the like.

The disclosed subject matter is described in the present application with reference to one or more specific exemplary embodiments thereof. It will be evident that various modifications may be made to the disclosed subject matter without departing from the broader spirit and scope of the disclosed subject matter as set forth in the appended claims. The specification and drawings are, accordingly, to be regarded in an illustrative sense for explanation of aspects of the disclosed subject matter rather than a restrictive or limiting sense. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method of reducing noise in biometric sensor image data produced by a biometric image sensor comprising:
capturing with the biometric image sensor a first frame of biometric image data;
capturing with the biometric image sensor a second frame of biometric image data;
selecting one of the first frame and the second frame as a reference frame;
filtering one of the reference frame and the other frame of the first frame and the second frame, respectively, with the other frame or the reference frame, and culling one of the other frame and the reference frame and selecting the un-culled one of the other frame and the reference frame as a new reference frame;
capturing with the biometric image sensor a new first frame;
filtering one of the new reference frame and the new first frame, respectively, with the other of the new first frame or the new reference frame, and culling one of the new first frame and the new reference frame and selecting the un-culled one of the new first frame and the new reference frame as a further new reference frame.

2. The method of claim 1, further comprising:
the first frame and the second frame each comprising, respectively, at least a portion of a respective first linear array sensor scan and a respective second linear array sensor scan.

3. The method of claim 1 further comprising:
the first frame and the second frame each comprising, respectively, at least a portion of a respective first two-dimensional array sensor scan and a respective second two-dimensional array sensor scan.

4. The method of claim 2 further comprising:
the culling one of the other frame and the reference frame and selecting the un-culled one of the other frame and the reference frame as a new reference frame comprising averaging the one of the at least a portion of a respective first linear array sensor scan and the at least a portion of the respective second linear array sensor scan.

5. The method of claim 4 further comprising:
selecting the un-culled one of the other linear array sensor scan and the reference linear array sensor scan comprises averaging the other linear array sensor scan and the reference linear array sensor scan; and
selecting the un-culled one of the new first linear array sensor scan and the new reference linear array sensor scan as a further new reference linear array sensor scan comprises averaging the new first linear array sensor scan and the further reference linear array sensor scan.

6. The method of claim 3 further comprising:
the culling one of the other frame and the reference frame and selecting the un-culled one of the other frame and the reference frame as a new reference frame comprising averaging the one of the at least a portion of a respective two-dimensional first array sensor scan and the at least a portion of the respective second two-dimensional array sensor scan.

7. The method of claim 6 further comprising:
selecting the un-culled one of the other two-dimensional sensor scan and the reference two-dimensional array sensor scan comprises averaging the other two-dimensional array sensor scan and the reference two-dimensional array sensor scan; and
selecting the un-culled one of the new first two-dimensional array sensor scan and the new reference two-dimensional array sensor scan as a further new reference two-dimensional array sensor scan comprises averaging the new first two-dimensional array sensor scan and the further reference two-dimensional array sensor scan.

8. The method of claim 2 further comprising:
determining whether at least a portion of an image of a finger is present in the respective first linear array sensor scan and the respective second linear array sensor scan.

9. The method of claim 3 further comprising:
determining whether at least a portion of an image of a finger is present in the respective first two-dimensional array sensor scan and the respective second two-dimensional array sensor scan.

10. A system for reducing noise in biometric sensor image data produced by a biometric image sensor comprising:
the biometric image sensor configured to:
capture a first frame of biometric image data; and
capture a second frame of biometric image data;
capture a new first frame of biometric image data;
a computing device configured to:
select one of the first frame and the second frame as a reference frame;
filter one of the reference frame and the other frame of the first frame and the second frame, respectively, with the other frame or the reference frame, and cull one of the other frame and the reference frame and select the un-culled one of the other frame and the reference frame as a new reference frame;
filter one of the new reference frame and the new first frame, respectively, with the other of the new first frame or the new reference frame, and cull one of the new first frame and the new reference frame and selecting the un-culled one of the new first frame and the new reference frame as a further new reference frame.

11. The system of claim 10, further comprising:
the first frame and the second frame each comprising, respectively, at least a portion of a respective first linear array sensor scan and a respective second linear array sensor scan.

12. The system of claim 10 further comprising:
the first frame and the second frame each comprising, respectively, at least a portion of a respective first two-dimensional array sensor scan and a respective second two-dimensional array sensor scan.

13. The system of claim 11 further comprising:
the computing device configured to:
cull one of the other frame and the reference frame and select the un-culled one of the other frame and the reference frame as a new reference frame by averaging the one of the at least a portion of a respective first linear array sensor scan and the at least a portion of the respective second linear array sensor scan.

14. The system of claim 13 further comprising:
the computing device configured to:
select the un-culled one of the other linear array sensor scan and the reference linear array sensor scan comprises by averaging the other linear array sensor scan and the reference linear array sensor scan; and
select the un-culled one of the new first linear array sensor scan and the new reference linear array sensor scan as a further new reference linear array sensor scan by averaging the new first linear array sensor scan and the further reference linear array sensor scan.

15. The system of claim 12 further comprising:
the computing device configured to:
cull one of the other frame and the reference frame and selecting the un-culled one of the other frame and the reference frame as a new reference frame by averaging the one of the at least a portion of a respective two-dimensional first array sensor scan and the at least a portion of the respective second two-dimensional array sensor scan.

16. The system of claim 15 further comprising:
the computing device configured to:
select the un-culled one of the other two-dimensional sensor scan and the reference two-dimensional array sensor scan by averaging the other two-dimensional array sensor scan and the reference two-dimensional array sensor scan; and
select the un-culled one of the new first two-dimensional array sensor scan and the new reference two-dimensional array sensor scan as a further new reference two-dimensional array sensor scan by averaging the new first two-dimensional array sensor scan and the further reference two-dimensional array sensor scan.

17. The system of claim 11 further comprising:
the computing device configured to:
determine whether at least a portion of an image of a finger is present in the respective first linear array sensor scan and the respective second linear array sensor scan.

18. The system of claim 12 further comprising:
the computing device configured to:
determine whether at least a portion of an image of a finger is present in the respective first two-dimensional array sensor scan and the respective second two-dimensional array sensor scan.

19. A machine readable medium storing software instructions which, when executed by a computing device, causes the computing device to perform a method, the method comprising:
capturing with the biometric image sensor a first frame of biometric image data;
capturing with the biometric image sensor a second frame of biometric image data;
selecting one of the first frame and the second frame as a reference frame;
filtering one of the reference frame and the other frame of the first frame and the second frame, respectively, with the other frame or the reference frame, and culling one of the other frame and the reference frame and selecting the un-culled one of the other frame and the reference frame as a new reference frame;
capturing with the biometric image sensor a new first frame;
filtering one of the new reference frame and the new first frame, respectively, with the other of the new first frame or the new reference frame, and culling one of the new first frame and the new reference frame and selecting the un-culled one of the new first frame and the new reference frame as a further new reference frame.

20. The machine readable medium of claim 19, the method further comprising:
the first frame and the second frame each comprising, respectively, at least a portion of a respective first two-dimensional array sensor scan and a respective second two-dimensional array sensor scan.
